(19) United States
(12) Patent Application Publication
(10) Pub. No.: US 2010/0231531 A1
(43) Pub. Date: Sep. 16, 2010

(54) TOUCH PANEL DEVICE

(76) Inventors: Byung-Duk Yang, Yongin-si (KR); Sung-Kyu Lee, Suwon-si (KR); Yong-Woo Lee, Suwon-si (KR); Se-Ki Park, Asan-si (KR); Sung-Wook Kang, Seoul (KR); Seong-Mo Hwang, Seongnam-si (KR); Jae-Hyun Kim, Suwon-si (KR); Su-Mi Lee, Yongin-si (KR)

Correspondence Address: HAYNES AND BOONE, LLP;IP Section, 2323 Victory Avenue, Suite 700, Dallas, TX, 75219, US

(21) Appl. No.: 12/551,809

(22) Filed: Sep. 1, 2009

(30) Foreign Application Priority Data
Mar. 10, 2009 (KR) 10-2009-0020451

(51) Int. Cl. G06F 3/041

(52) U.S. Cl. 345/173

(57) ABSTRACT

Embodiments of the present invention relate to a touch panel device. A touch panel device according to an exemplary embodiment of the present invention includes a touch panel and a touch panel controller for controlling the touch panel, wherein the touch panel includes a lower electrode layer, a solid insulating layer disposed on the lower electrode layer, a fluent insulating layer disposed on the solid insulating layer, and an upper electrode layer disposed on the fluent insulating layer.

### CROSS-REFERENCE TO RELATED APPLICATION

This application claims priority to and the benefit of Korean Patent Application No. 10-2009-0020451 filed in the Korean Intellectual Property Office on Mar. 10, 2009, the entire contents of which are incorporated herein by reference.

### BACKGROUND

(a) Technical Field

Embodiments of the present invention generally relate to a touch panel device, and more particularly, to a touch panel device for a multi-touch sensing.

(b) Description of the Related Art

A display device of a liquid crystal display and an organic light emitting device, a portable transmitting device, and other information processing devices execute a function thereof by using various input devices. Recently, an input device provided with a touch panel has been largely used.

The touch panel is a device for allowing a machine such as a computer to perform a desired command by writing a character, drawing a picture, or executing an icon through touching a finger or a touch pen (or a stylus) on a screen. A display device to which the touch panel is attached can determine whether a user finger or a touch pen, etc., touches a screen, and touch position information thereof.

These touch panels are largely classified as a resistive type, a capacitive type, or an electromagnetic (EM) type according to the sensing method of the touch.

Among them, the resistive type of touch panel includes upper and lower transparent electrodes separated from each other by a spacer. If an upper plate formed with the upper transparent electrode is depressed by external contact such that the upper transparent electrode and the lower transparent electrode physically contact each other, the contacts and the contact position may be determined by measuring the voltage changed according to the resistance of the depressed position. The resistive type of touch panel may be operated regardless of the conductivity of the contact matter. However, when several positions are simultaneously touched, the values of the changed voltages are recognized as one such that it is difficult to obtain the touch information of the several positions.

The capacitance type of touch panel includes a film formed with a transparent electrode, and touch existence and touch positions may be determined by measuring a voltage change of the finger conductive matter by the contact after applying a voltage to the transparent electrode. This capacitance type may obtain the contact existence and the contact position although various positions are contacted, however, the voltage change is not generated in the case that an insulator such as gloves contacts such that the contact information may not be obtained.

The above information disclosed in this Background section is only for enhancement of understanding of the background of the disclosure and therefore it may contain information that does not form the prior art that is already known in this country to a person of ordinary skill in the art.

### SUMMARY

A touch panel device according to an exemplary embodiment of the present invention includes a touch panel and a touch panel controller for controlling the touch panel, wherein the touch panel includes a lower electrode layer, a solid insulating layer disposed on the lower electrode layer, a fluent insulating layer disposed on the solid insulating layer, and an upper electrode layer disposed on the fluent insulating layer.

The lower electrode layer may include a plurality of lower electrodes having a belt shape and extending in a first direction and the upper electrode layer includes a plurality of upper electrodes having a belt shape and extending in a second direction, and the first direction and the second direction may cross each other.

A width of the lower electrodes or a width of the upper electrode may be different according to position.

The width of the lower electrode or the width of the upper electrode may gradually change according to position.

At least one of a thickness of the fluent insulating layer and a thickness of the solid insulating layer may change according to position.

At least one of the thickness of the fluent insulating layer and the thickness of the solid insulating layer may gradually change according to position.

A plurality of first input signal lines each connecting a first terminal of the upper electrode to the touch panel controller, a plurality of first output signal lines each connecting a second terminal of the upper electrode to the touch panel controller, a plurality of second input signal lines each connecting a first terminal of the lower electrode to the touch panel controller, and a plurality of second output signal lines each connecting a second terminal of the lower electrode to the touch panel controller may be further included.

The plurality of first output signal lines may be grouped as one signal line to be connected to the touch panel controller, and the plurality of second output signal lines may be grouped as one signal line to be connected to the touch panel controller.

The fluent insulating layer may include a liquid crystal material.

The fluent insulating layer may include a plurality of spacers maintaining a thickness of the fluent insulating layer.

A touch panel device according to another exemplary embodiment of the present invention includes a touch panel and a touch panel controller for controlling the touch panel, wherein the touch panel includes a lower electrode layer including a plurality of lower electrodes and an insulating layer disposed on the lower electrode, and an upper electrode layer disposed on the insulating layer and including a plurality of upper electrodes intersecting the lower electrodes, wherein a width of the lower electrode or a width of the upper electrode is different according to position.

The width of the lower electrode or the width of the upper electrode may gradually change according to position.

A plurality of first input signal lines each connecting a first terminal of the upper electrode to the touch panel controller, a plurality of first output signal lines each connecting a second terminal of the upper electrode to the touch panel controller, a plurality of second input signal lines each connecting a first terminal of the lower electrode to the touch panel controller, and a plurality of second output signal lines each connecting a second terminal of the lower electrode to the touch panel controller may be further included.

The plurality of first output signal lines may be grouped as one signal line to be connected to the touch panel controller, and the plurality of second output signal lines may be grouped as one signal line to be connected to the touch panel controller.

### BRIEF DESCRIPTION OF THE DRAWINGS

FIG. 1 is a block diagram of a touch panel device according to an exemplary embodiment of the present invention,

FIG. 2 is a cross-sectional view of a touch panel according to an exemplary embodiment of the present invention,

FIG. 3 is a cross-sectional view of a portion of the touch panel shown in FIG. 2 according to an embodiment,

FIG. 4 is a cross-sectional view of a portion of the touch panel shown in FIG. 2 while being touched, according to an embodiment,

FIG. 5 is a cross-sectional view of the touched touch panel shown in FIG. 4 according to an embodiment,

FIG. 6 is a cross-sectional view of a touch panel according to another exemplary embodiment of the present invention,

FIG. 7 is a layout view showing upper and lower electrodes and an output signal line of a touch panel device according to another exemplary embodiment of the present invention,

FIG. 8 is a view showing an input signal and an output signal of the touch panel device shown in FIG. 7 according to an embodiment,

FIG. 9 is a layout view of upper and lower electrodes of a touch panel according to another exemplary embodiment of the present invention,

FIG. 10 is a layout view showing upper and lower electrodes and an output signal line of a touch panel device according to another exemplary embodiment of the present invention,

FIG. 11 is a layout view of upper and lower electrodes of a touch panel according to another exemplary embodiment of the present invention,

FIG. 12 is a cross-sectional view of the touch panel shown in FIG. 11 taken along the line XII-XII according to an embodiment,

FIG. 13 is a layout view of upper and lower electrodes of a touch panel according to another exemplary embodiment of the present invention, and

FIG. 14 is a cross-sectional view of the touch panel shown in FIG. 13 taken along the line XIV-XIV according to an embodiment.

### DETAILED DESCRIPTION

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element, or intervening elements may also be present. In contrast, when an element is referred to as being “directly on” another element, there are no intervening elements present.

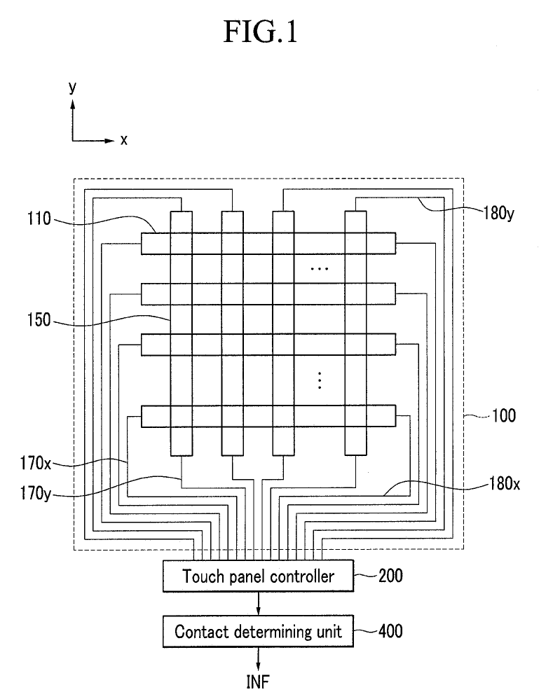

First, a touch panel device according to an exemplary embodiment of the present invention will be described with reference to FIG. 1 to FIG. 3.

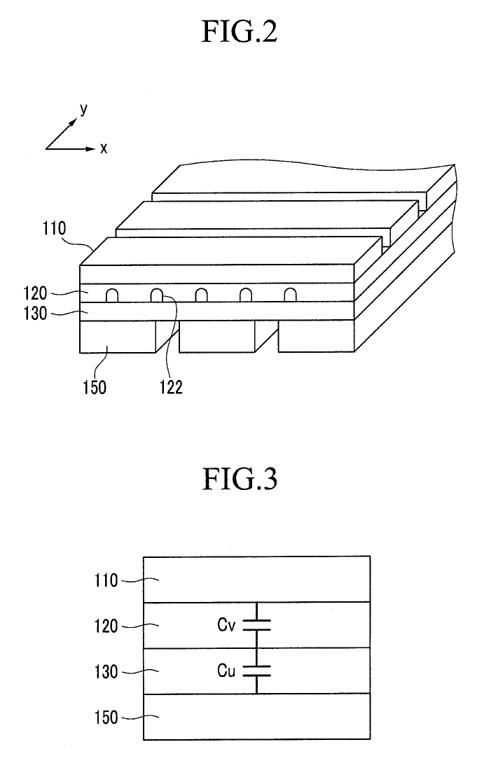

FIG. 1 is a block diagram of a touch panel device according to an exemplary embodiment of the present invention, FIG. 2 is a cross-sectional view of a touch panel according to an exemplary embodiment of the present invention, and FIG. 3 is a cross-sectional view of a portion of the touch panel shown in FIG. 2 according to an embodiment.

Referring to FIG. 1, a touch panel device according to an exemplary embodiment of the present invention includes a touch panel 100, a touch panel controller 200 connected to the touch panel 100, and a contact determining unit 400 connected to the touch panel controller 200.

Referring to FIG. 1 and FIG. 2, the touch panel 100 includes an upper electrode layer including a plurality of upper electrodes 110, a lower electrode layer including a plurality of lower electrodes 150, and a fluent dielectric layer 120 and a solid insulating layer 130 interposed between the upper electrodes 110 and the lower electrodes 150.

The upper electrodes 110 approximately extend in the x direction and are parallel to each other, and the lower electrodes 150 approximately extend in the y direction and are parallel to each other. The upper electrodes 110 are separated from each other by a predetermined interval, and the lower electrodes 150 are separated from each other by a predetermined interval. The upper electrodes 110 and the lower electrodes 150 may be made of a transparent conductive material such as indium tin oxide (ITO) or indium zinc oxide (IZO). Differently from the embodiment of FIG. 1, the upper electrodes 110 may extend in the y direction and the lower electrodes 150 may extend in the x direction.

The solid insulating layer 130 is disposed on the lower electrodes 150. The solid insulating layer 130 may be made of a solid transparent insulating material such as silicon nitride (SiNx) or silicon oxide (SiOx).

The fluent insulating layer 120 is disposed on the solid insulating layer 130, and is made of a fluent insulating material. For example, the fluent insulating layer 120 may be made of a liquid crystal material including a PVA liquid crystal. The dielectric constant of the fluent insulating layer 120 may be in a range of 3 to 4, but is not limited thereto, and may be selected considering the transmittance or stability of the touch panel 100. On the other hand, the fluent insulating layer 120 includes a plurality of spacers 122 formed on the solid insulating layer 130. The spacers 122 may maintain the interval between the solid insulating layer 130 and the upper electrode 110, that is, the thickness of the fluent insulating layer 120. The spacers 122 may include dot spacers.

As shown in FIG. 3, the interface of the fluent insulating layer 120 and the solid insulating layer 130, and the upper electrode 110 opposing thereto, form an upper capacitor Cv, and the fluent insulating layer 120 therebetween functions as a dielectric material. Also, the interface of the fluent insulating layer 120 and the solid insulating layer 130, and the lower electrode 150 opposing thereto, form a lower capacitor Cu, and the solid insulating layer 130 therebetween functions as the dielectric material. Accordingly, the total capacitance Ct of the upper and lower capacitors Cv and Cu, that is, the capacitance of the entire capacitor Ct including the upper and lower electrodes 110 and 150 as two terminals, is indicated by Equation 1.

Ct=Cv*Cu/(Cv+Cu) (Equation 1)

In Equation 1, the upper capacitor Cv, the lower capacitor Cu, and the entire capacitor Ct, and the capacitances thereof, are indicated by the same reference numerals.

Also, an insulating layer (not shown) covering and protecting the upper electrode 110 may be further formed.

Again referring to FIG. 1, the touch panel controller 200 is connected to one terminal of the upper electrode 110 of the touch panel 100 through a first input signal line 170x, and to one terminal of the lower electrode 150 of the touch panel 100 through a second input signal line 170y. Also, the touch panel controller 200 is connected to the other terminal of the upper electrode 110 through a first output signal line 180x, and to the other terminal of the lower electrode 150 through a second output signal line 180y.

The touch panel controller 200 transmits an input signal to the upper electrode 110 and the lower electrode 150 through the first and second input signal lines 170x and 170y, and receives an output signal of the upper electrode 110 and the lower electrode 150 through the first and second output signal lines 180x and 180y. The touch panel controller 200 processes the output signal to generate a sensing signal.

The contact determining unit 400 receives the sensing signal from the touch panel controller 200 to calculate and process it, determines a contact existence and a contact position, and generates contact information INF to be output to an external device (not shown). The external device may transmit an image signal to a display device such as a liquid crystal display or an organic light emitting device based on the contact information INF. The contact determining unit 400 may be omitted.

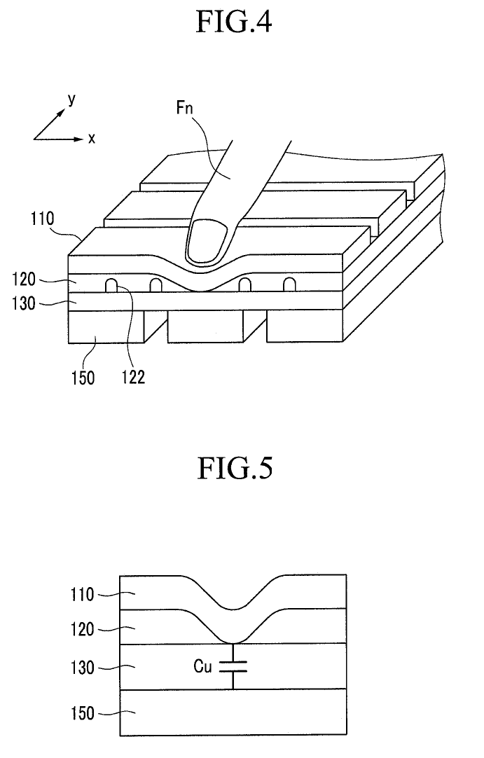

Next, a method for sensing a contact position of the touch panel device shown in FIG. 1 to FIG. 3 will be described with reference to FIG. 4 and FIG. 5 as well as FIG. 1 to FIG. 3 according to one or more embodiments.

FIG. 4 is a cross-sectional view of a portion of the touch panel shown in FIG. 2 while being touched, according to an embodiment, and FIG. 5 is a cross-sectional view of the touched touch panel shown in the embodiment of FIG. 4.

The touch panel controller 200 transmits an input signal to the upper electrode 110 through the first input signal line 170x. The input signal may be an AC voltage having a predetermined frequency and voltage magnitude.

Next, as shown in FIG. 4 and FIG. 5, in the state that the upper electrode 110 is transmitted with the input signal, if a pressure by a touch of a finger Fn of a user or the like is applied to the touch panel 100, the upper electrode 110 at the touch position is pressed downward such that a portion of the upper electrode 110 contacts the upper surface of the solid insulating layer 130. Here, the external contact object is not limited by the conductivity and the characteristics thereof.

The upper capacitor Cv is eliminated and only the lower capacitor Cu remains at the contact position such that the capacitance of the entire capacitor Ct including the upper and lower electrodes 110 and 150 as two terminals is equal to the capacitance of the lower capacitor Cu. Accordingly, when a contact is applied, the capacitance of the entire capacitor Ct of the contact position is changed by ΔCt according to the following Equation 2.

ΔCt=Cu−Cv*Cu/(Cv+Cu)=Cu²/(Cu+Cv) (Equation 2)

As above-described, if the capacitance of the entire capacitor Ct including the upper and lower electrodes 110 and 150 is changed, the frequency and the voltage magnitude of the output signal transmitted through the lower electrode 150 corresponding to the contact position are changed.

The changed output signal is transmitted to the touch panel controller 200 through the second output signal line 180y connected to the lower electrode 150 corresponding to the contact position. Here, the capacitance of the entire capacitor Ct formed by the lower electrode 150 and the upper electrode 110 at the portion where no contact is applied is not changed such that the frequency and the voltage magnitude of the output signal transmitted through the second output signal line 180y connected to the lower electrode 150 of the portion where no contact is applied is little (slightly) changed. However, the frequency and the voltage magnitude of the output signal from the lower electrode 150 near the contact position may be changed.

Referring to Equation 2, the signal to noise ratio may be increased as the capacitance of the lower capacitor Cu is increased such that determination of the contact position may be further simplified.

The touch panel controller 200 that has received the changed output signal processes the output signal to generate a sensing signal, and transmits it to the contact determining unit 400 thereby determining contact existence and the x coordinate of the contact position.

After sensing the x coordinate of the contact position as above, the touch panel controller 200 transmits an input signal to the lower electrode 150 through the second input signal line 170y, and the y coordinate of the contact position may be sensed by repeating a process that is similar to that described above. As above-described, the application of the input signal to the upper electrode 110 and the lower electrode 150 are alternately repeated, and the sequence thereof may be exchanged.

According to the present exemplary embodiment, although several positions of the touch panel 100 may be simultaneously contacted, the contact information of each position may be obtained through the change of the capacitance of the entire capacitor Ct at each contact position.

Also, according to the present exemplary embodiment, the contact existence and the contact position of the touch panel 100 may be detected regardless of the conductivity of the external contact matter.

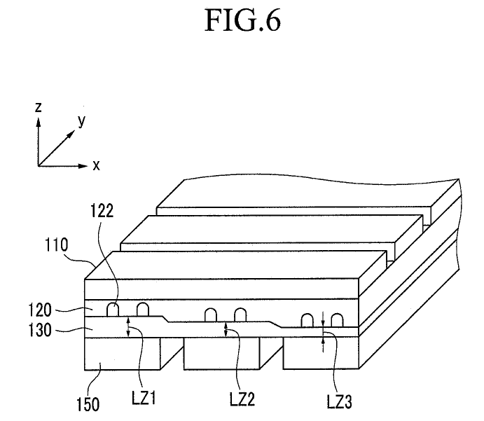

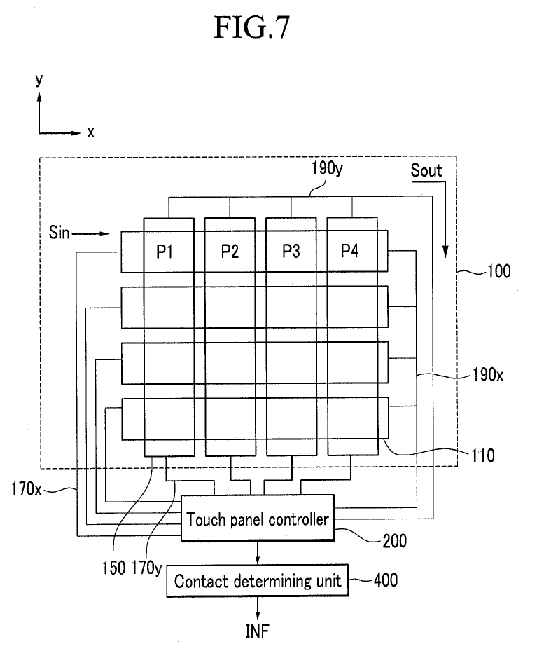

Next, the touch panel device according to another exemplary embodiment of the present invention will be described with reference to FIG. 6 and FIG. 7.

FIG. 6 is a cross-sectional view of a touch panel according to another exemplary embodiment of the present invention, and FIG. 7 is a layout view showing upper and lower electrodes and an output signal line of a touch panel device according to another exemplary embodiment of the present invention.

The same constituent elements as the previous exemplary embodiments are indicated by the same reference numerals, and the same description is omitted.

Referring to FIG. 1, FIG. 6 and FIG. 7, a touch panel device according to the current exemplary embodiment of the present invention also includes a touch panel 100, a touch panel controller 200 connected to the touch panel 100, and a contact determining unit 400 connected to the touch panel controller 200.

The touch panel 100 includes an upper electrode layer including a plurality of upper electrodes 110 extending in the x direction, a lower electrode layer including a plurality of lower electrodes 150 extending in the y direction, and a fluent dielectric layer 120 and a solid insulating layer 130 interposed between the upper electrodes 110 and the lower electrodes 150.

The touch panel controller 200 is connected to one terminal of each upper electrode 110 of the touch panel 100 through the first input signal line 170x, and to one terminal of each lower electrode 150 of the touch panel 100 through the second input signal line 170y.

However, differently from the previous exemplary embodiment, the touch panel controller 200 according to the present exemplary embodiment is connected to the other terminal of the upper electrode 110 through a third output signal line 190x, and connected to the other terminal of the lower electrode 150 through a fourth output signal line 190y.

One third output signal line 190x may be connected to one or a plurality of upper electrodes 110, and one fourth output signal line 190y may be connected to one or a plurality of lower electrodes 150. In the exemplary embodiment of FIG. 7, one third output signal line 190x is connected to a plurality of upper electrodes 110, and one fourth output signal line 190y is connected to a plurality of lower electrodes 150.

Also, the touch panel controller 200 may be connected to the upper electrodes 110 through one or a plurality of the third output signal lines 190x, and to the lower electrodes 150 through one or a plurality of the fourth output signal lines 190y. In FIG. 7, one third output signal line 190x is connected to all upper electrodes 110, and one fourth output signal line 190y is connected to all lower electrodes 150.

Referring to FIG. 6, the thicknesses LZ1, LZ2, LZ3, . . . of the solid insulating layer 130 are different according to the positions of the corresponding lower electrodes 150 or upper electrodes 110. Accordingly, the thickness of the fluent insulating layer 120 is different according to position. As shown in FIG. 6, the thicknesses LZ1, LZ2, LZ3, . . . of the solid insulating layer 130 may be gradually increased or decreased according to the positions corresponding to the lower electrodes 150, or may be gradually increased or decreased according to the positions corresponding to the upper electrodes 110. Also, the thickness of the solid insulating layer 130 may be different for every position where the upper electrodes 110 and the lower electrodes 150 are crossed.

The solid insulating layer 130 having the different thickness depending on position may be formed by depositing a photosensitive organic layer on the lower electrodes 150, and exposing it to light and developing it through a photo-mask including a half tone of several degrees.

As above-described, the thicknesses LZ1, LZ2, LZ3, . . . of the solid insulating layer 130 may be varied according to position such that the capacitance of the lower capacitor Cu formed by the interface of the fluent insulating layer 120 and solid insulating layer 130 with the lower electrode 150 facing thereto, and the capacitance of the upper capacitor Cv formed by the interface of the fluent insulating layer 120 and solid insulating layer 130 with the upper electrode 110 facing thereto, may be different according to position.

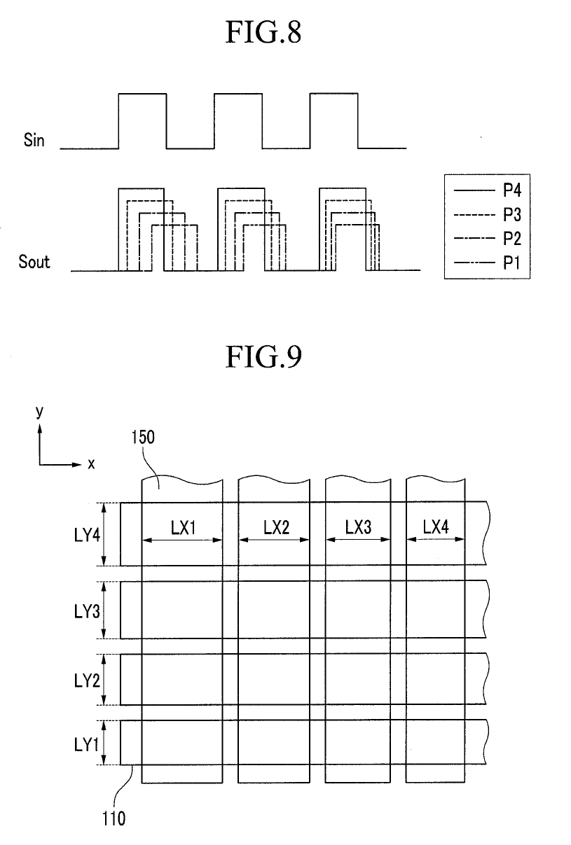

Next, a sensing method of the contact position of the touch panel device shown in FIG. 6 and FIG. 7 will be described with reference to FIG. 8 according to an embodiment.

FIG. 8 is a view showing an input signal and an output signal of the touch panel shown in the embodiment of FIG. 7.

As shown in FIG. 7, during the time that the touch panel controller 200 transmits the input signal Sin to the upper electrode 110, if contact from the outside is applied at the different positions P1, P2, P3, and P4, the upper electrode 110 of the positions P1, P2, P3, and P4 where the contact is applied is pressed like the previous exemplary embodiment such that the upper electrode 110 contacts the upper surface of the solid insulating layer 130. Thus, the upper capacitor Cv is eliminated and only the lower capacitor Cu remains at the contact positions P1, P2, P3, and P4 such that the capacitance of the entire capacitor Ct including the upper and lower electrodes 110 and 150 as two terminals is equal to the capacitance of the lower capacitor Cu. Accordingly, the capacitance of the entire capacitor Ct at the contact position after applying the contact is changed by ΔCt of Equation 2.

Here, as shown in FIG. 6, the thicknesses LZ1, LZ2, LZ3, . . . of the solid insulating layer 130 are different according to positions of the lower electrodes 150 such that the capacitance of the lower capacitor Cu formed by the interface of the fluent insulating layer 120 and solid insulating layer 130 and the lower electrode 150 facing thereto, and the capacitance of the upper capacitor Cv formed by the interface of the fluent insulating layer 120 and solid insulating layer 130 and the upper electrode 110 facing thereto, are different according to position of the touch panel 100. Also, the capacitance of the entire capacitor Ct according to Equation 2 and the variation ΔCt thereof are different according to the contact positions P1, P2, P3, and P4. Accordingly, as shown in FIG. 8, variations in the frequency and the voltage magnitude of the output signal Sout transmitted through the lower electrode 150 are different according to the contact positions P1, P2, P3, and P4.

For example, in the case that the thicknesses LZ1, LZ2, LZ3, . . . of the solid insulating layer 130 are gradually increased according to the order of the contact positions P1, P2, P3, and P4, the capacitance of the lower capacitor Cu is gradually decreased, and simultaneously the capacitance of the upper capacitor Cv is gradually increased, and the variation ΔCt of the entire capacitor Ct is decreased. Thus, as shown in FIG. 8, the variations in the frequency and the voltage magnitude of the output signal Sout are decreased according to the order of the contact positions P1, P2, P3, and P4. That is, the frequency and the voltage of the output signal Sout are decreased according to the order of the contact positions P1, P2, P3, and P4.

As above-described, the contact information such as the x coordinate of each of the contact positions P4, P3, P2, and P1 may be obtained through the output signal Sout distinguished by the contact positions P4, P3, P2, and P1.

After sensing the x coordinates of the contact position, the touch panel controller 200 transmits the input signal Sin to the lower electrode 150 through the second input signal line 170y, and the y coordinate of the contact position may be sensed by repeating a similar process to that described above. The application of the input signal Sin for the upper electrode 110 and the lower electrode 150 are alternately repeated, and the sequence thereof may be exchanged.

As above-described, although several positions of the touch panel 100 are simultaneously contacted, the output signal Sout is distinguished according to the positions of the lower electrode 150 or the upper electrode 110 such that a plurality of lower electrodes 150 or upper electrodes 110 may be connected to the touch panel controller 200 through one fourth output signal line 190y or one third output signal line 190x, and the contact information of all contact positions may be sensed. Also, the number of third and fourth output signal lines 190x and 190y may be reduced such that the transmittance of the touch panel device may be increased.

The various characteristics and the effects of the previous exemplary embodiment may be applied to the exemplary embodiment shown in FIG. 6 to FIG. 8.

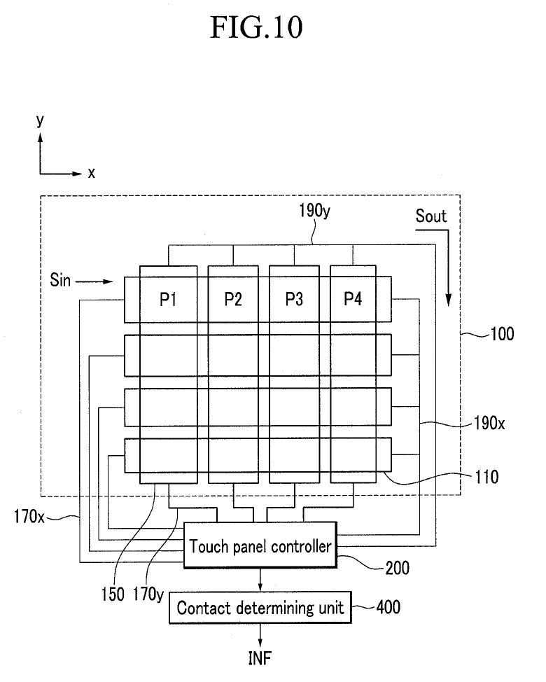

Next, the touch panel device according to another exemplary embodiment of the present invention will be described with reference to FIG. 9 and FIG. 10.

FIG. 9 is a layout view of upper and lower electrodes of a touch panel according to another exemplary embodiment of the present invention, and FIG. 10 is a layout view showing upper and lower electrodes and an output signal line of a touch panel device according to another exemplary embodiment of the present invention.

The same constituent elements as the previous exemplary embodiments are indicated by the same reference numerals, and the same description is omitted.

Referring to FIG. 9 and FIG. 10, a touch panel device according to the current exemplary embodiment of the present invention includes a touch panel 100, a touch panel controller 200 connected to the touch panel 100, and a contact determining unit 400 connected to the touch panel controller 200.

The touch panel 100 includes an upper electrode layer including a plurality of upper electrodes 110 extending in the x direction, and a lower electrode layer including a plurality of lower electrodes 150 extending in the y direction. The touch panel 100 may further include an insulating layer such as a fluent insulating layer (not shown) or a solid insulating layer (not shown) disposed between the upper electrodes 110 and the lower electrodes 150.

The touch panel controller 200 is connected to one terminal of each upper electrode 110 of the touch panel 100 through the first input signal line 170x, and one terminal of each lower electrode 150 of the touch panel 100 through the second input signal line 170y. Also, the touch panel controller 200 is connected to the other terminal of the upper electrode 110 through the third output signal line 190x, and is connected to the other terminal of the lower electrode 150 through the fourth output signal line 190y. One third output signal line 190x and one fourth output signal line 190y are connected through one or a plurality of upper electrodes 110 and lower electrodes 150. Also, the touch panel controller 200 may be connected to the upper electrode 110 through one or a plurality of the third output signal lines 190x, and may be connected to the lower electrode 150 through one or a plurality of the fourth output signal lines 190y.

Referring to FIG. 9, the widths LX1, LX2, LX3, LX4 . . . of the lower electrodes 150 are different according to position, and the widths LY1, LY2, LY3, LY4, . . . of the upper electrodes 110 may be different according to position. For example, as shown in the embodiment of FIG. 9 or according to the below Equation 3, the widths LX1, LX2, LX3, LX4, . . . of the lower electrodes 150 or the widths LY1, LY2, LY3, LY4, . . . of the upper electrodes 110 may be gradually increased or decreased.

LX1>LX2>LX3>LX4

LY1<LY2<LY3<LY4 (Equation 3)

As above-described, the width of the upper electrodes 110 or the lower electrodes 150 are different according to the positions of the electrodes such that the capacitance of the capacitor formed through overlapping of the lower electrodes 150 and the upper electrodes 110 may be different according to the positions.

Next, a sensing method of the contact position of the touch panel device shown in FIG. 9 and FIG. 10 will be described with reference to FIG. 3 and FIG. 8 according to an embodiment.

First, an example including the fluent insulating layer 120 and the solid insulating layer 130 shown in FIG. 3 in the touch panel device shown in FIG. 9 and FIG. 10 will be described according to an embodiment.

As shown in FIG. 10, during the time that the touch panel controller 200 transmits the input signal Sin to the upper electrode 110, if a contact from the outside is applied to the different positions P1, P2, P3, and P4, the upper electrodes 110 of the positions P1, P2, P3, and P4 where the contact is applied is pressed as above-described such that the upper electrode 110 contacts the upper surface of the solid insulating layer 130 shown in FIG. 3. Thus, the upper capacitor Cv is eliminated and only the lower capacitor Cu remains at the contact positions P1, P2, P3, and P4 such that the capacitance of the entire capacitor Ct including the upper and lower electrodes 110 and 150 as two terminals is equal to the capacitance of the lower capacitor Cu. Accordingly, the capacitance of the entire capacitor Ct at the contact position after applying the contact is changed by ΔCt of Equation 2.

Here, as shown in FIG. 9, since the widths of the upper electrodes 110 and the lower electrodes 150 are different according to positions of the electrodes, the capacitance of the lower capacitor Cu formed by the interface of the fluent insulating layer 120 and solid insulating layer 130, and the lower electrode 150 facing thereto, and the capacitance of the upper capacitor Cv formed by the interface of the fluent insulating layer 120 and solid insulating layer 130, and the upper electrode 110 facing thereto, are different according to positions of the touch panel 100. Also, the capacitance of the entire capacitor Ct according to Equation 2 and the variation ΔCt thereof are different according to the contact positions P1, P2, P3, and P4. Accordingly, as shown in FIG. 8, the variations in the frequency and the voltage magnitude of the output signal Sout through the lower electrodes 150 are different according to the contact positions P1, P2, P3, and P4.

For example, when the width of the lower electrode 150 and the upper electrode 110 satisfies Equation 3, the capacitance of the lower and upper capacitors Cu and Cv is gradually decreased according to the order of the contact positions P1, P2, P3, and P4 of FIG. 10, and the entire capacitor Ct and the variation ΔCt thereof are also decreased in that order. Thus, as shown in FIG. 8, the variations of the frequency and the voltage magnitude of the output signal Sout are decreased according to the order of the contact positions P1, P2, P3, and P4, and the frequency and the voltage of the output signal Sout are decreased according to the contact positions P4, P3, P2, and P1.

As above-described, although several positions of the touch panel 100 are simultaneously contacted, the output signal Sout is distinguished according to the positions of the lower electrodes 150 or the upper electrodes 110 such that a plurality of lower electrodes 150 or upper electrodes 110 may be connected to the touch panel controller 200 through one fourth output signal line 190y or one third output signal line 190x, and the contact information of all contact positions may be sensed. Also, the number of third and fourth output signal lines 190x and 190y may be reduced such that the transmittance of the touch panel device may be increased.

On the other hand, according to another exemplary embodiment of the present invention, the fluent insulating layer (not shown) is omitted between the upper electrode 110 and the lower electrode 150, and one insulating layer such as the solid insulating layer (not shown) may be interposed therebetween. In this case, during the time that the touch panel controller 200 transmits the input signal Sin to the upper electrode 110, if the contact from the outside is applied at the different positions P1, P2, P3, and P4, as shown in FIG. 10, the capacitances of the capacitors formed by overlapping of the lower electrode 150 and the upper electrode 110 vary according to positions such that the variation in the frequency and the voltage of the output signal Sout transmitted through the lower electrode 150 is different according to the contact positions P1, P2, P3, and P4, as shown in FIG. 8.

For example, when the widths of the lower electrode 150 and the upper electrode 110 satisfy Equation 3, the capacitance of the capacitors formed by overlapping the lower electrode 150 and the upper electrode 110 is gradually decreased according to the order of the contact positions P1, P2, P3, and P4. Thus, as shown in FIG. 8, the variations in the frequency and the voltage magnitude of the output signal Sout may be decreased according to the order of the contact positions P1, P2, P3, and P4, and the frequency and the voltage of the output signal Sout may be decreased according to the order of the contact positions P4, P3, P2, and P1.

However, like the present exemplary embodiment, when only one insulating layer such as the solid insulating layer (not shown) is interposed between the upper electrode 110 and the lower electrode 150, the contact object from the outside may be conductive.

The various characteristics and effects of the previous exemplary embodiment may be applied to the exemplary embodiment shown in FIG. 9 to FIG. 10.

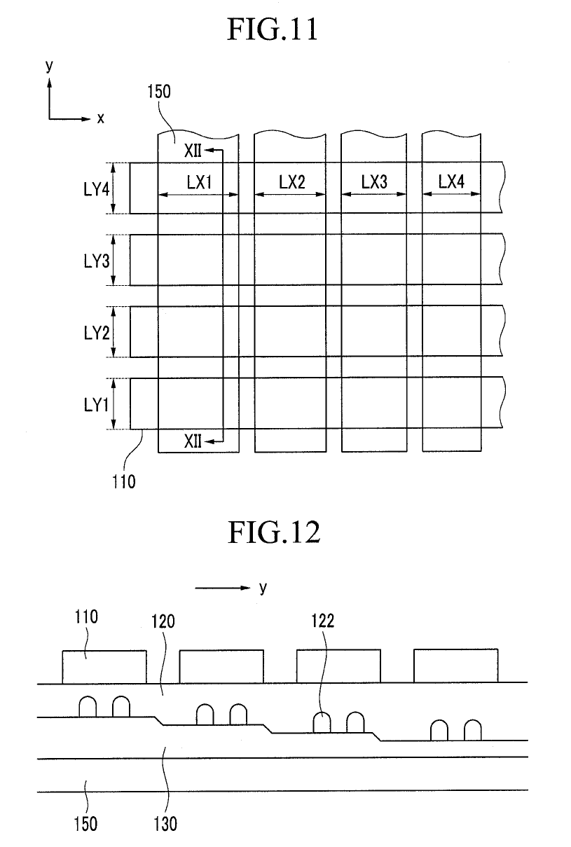

Next, the touch panel device according to another exemplary embodiment of the present invention will be described with reference to FIG. 11 to FIG. 14.

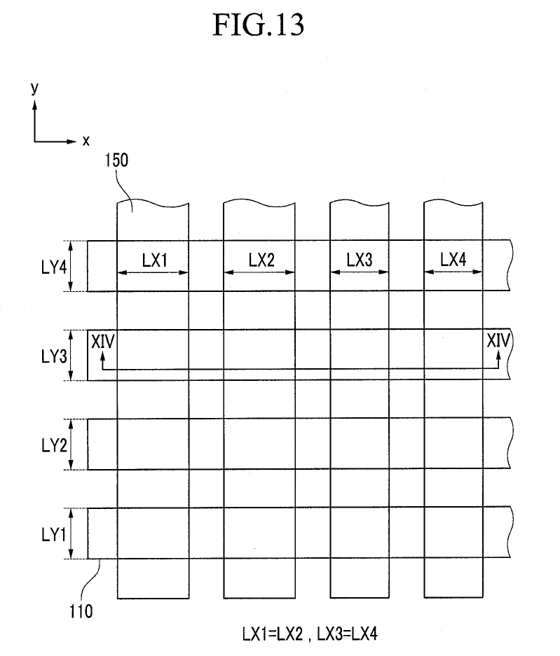

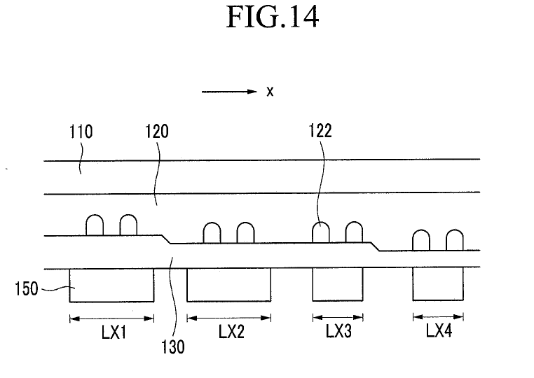

FIG. 11 is a layout view of upper and lower electrodes of a touch panel according to another exemplary embodiment of the present invention, FIG. 12 is a cross-sectional view of the touch panel shown in the embodiment of FIG. 11 taken along the line XII-XII, FIG. 13 is a layout view of upper and lower electrodes of a touch panel according to another exemplary embodiment of the present invention, and FIG. 14 is a cross-sectional view of the touch panel shown in the embodiment of FIG. 13 taken along the line XIV-XIV.

The same constituent elements as the previous exemplary embodiment are indicated by the same reference numerals, and the same description is omitted.

Referring to FIG. 11 and FIG. 12, a touch panel device according to the current exemplary embodiment of the present invention includes a plurality of upper electrodes 110 extending in the x direction, a plurality of lower electrodes 150 extending in the y direction, and a fluent insulating layer 120 and a solid insulating layer 130 interposed between the upper electrodes 110 and the lower electrodes 150.

As shown in FIG. 12, the thickness of the solid insulating layer 130 may be gradually decreased or increased according to the y direction, and the thickness of the solid insulating layer 130 may be uniform according to the x direction. However, the thickness of the solid insulating layer 130 may be gradually decreased or increased according to the x direction.

The widths LX1, LX2, LX3, LX4, . . . of the lower electrode 150 are gradually decreased or increased according the order thereof, and the widths LY1, LY2, LY3, and LY4 of the upper electrodes 110 are uniform. In FIG. 11, the widths LX1, LX2, LX3, LX4, . . . of the lower electrodes 150 satisfy the relationship of LX1>LX2>LX3>LX4. However, the widths LY1, LY2, LY3, and LY4 of the upper electrode 110 may be gradually increased or decreased.

As above-described, the thickness of the solid insulating layer 130 is varied according to the positions, and simultaneously the widths of the lower electrodes 150 or the upper electrodes 110 are varied according to position, such that the variation in the frequency and the voltage magnitude of the output signal Sout may be different according to the contact positions, thereby reducing the number of output signal lines. Also, the difference of the variation in the frequency and the voltage magnitude of the output signal Sout according to positions may be further increased by changing the thickness of the solid insulating layer 130 according to the x or y direction, and simultaneously changing the widths of the lower electrodes 150 or the upper electrodes 110.

Referring to FIG. 13 and FIG. 14, a touch panel device according to the current exemplary embodiment of the present invention includes a plurality of upper electrodes 110 extending in the x direction, a plurality of lower electrodes 150 extending in the y direction, and a fluent insulating layer 120 and a solid insulating layer 130 interposed between the upper electrodes 110 and the lower electrodes 150.

As shown in FIG. 14, the thickness of the solid insulating layer 130 may be gradually decreased or increased according to the x direction, and may be gradually decreased or increased according to positions corresponding to two lower electrodes 150.

The widths LY1, LY2, LY3, LY4, . . . of the upper electrodes 110 may be gradually decreased or increased according to the order thereof, and the widths LX1, LX2, LX3, LX4, . . . of the lower electrodes 150 may be gradually decreased or increased every two lower electrodes 150. That is, it may be that LX1=LX2 and LX3=LX4.

Differently from the present exemplary embodiment, in alternate embodiments, the widths of the lower electrodes 150 or the upper electrodes 110 may be gradually increased or decreased according to the x or y direction by more than three. For the lower electrodes 150 or the upper electrodes 110 having the same width, the thickness of the solid insulating layer 130 overlapping the lower electrodes 150 and the upper electrodes 110 may be changed so that the same effect as the previous exemplary embodiment may be obtained.

In addition, the number of signal lines of the touch panel device may be reduced by increasing the deviation of the frequency or the voltage magnitude of the output signal according to positions of the touch panel through various other methods according to one or more embodiments.

The various characteristics of the present disclosure may be applied to the touch panel device of the other structure according to one or more embodiments.

Like an exemplary embodiment of the present invention, the fluent insulating layer and the solid insulating layer may be disposed between the upper electrode and the lower electrode such that the contact information may be sensed regardless of the conductivity of the contact matter.

Also, by using the output signal lines connected to a plurality of upper electrodes and a plurality of lower electrodes, contact information such as a contact existence at more than two positions in the touch panel may be obtained.

Also, the thickness of the fluent insulating layer or the solid insulating layer between the upper electrodes and the lower electrodes may be varied according to position, or the widths of the upper electrodes or the lower electrodes may be varied according to position, such that the number of signal lines of the touch panel may be reduced.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A touch panel device comprising:
a touch panel; and
a touch panel controller for controlling the touch panel,
wherein the touch panel includes:
a lower electrode layer,
a solid insulating layer disposed on the lower electrode layer,
a fluent insulating layer disposed on the solid insulating layer, and
an upper electrode layer disposed on the fluent insulating layer.

2. The touch panel device of claim 1, wherein
the lower electrode layer includes a plurality of lower electrodes having a belt shape and extending in a first direction, and the upper electrode layer includes a plurality of upper electrodes having a belt shape and extending in a second direction, and
the first direction and the second direction cross each other.

3. The touch panel device of claim 2, wherein
a width of the lower electrode or a width of the upper electrode is different according to position.

4. The touch panel device of claim 3, wherein
the width of the lower electrode or the width of the upper electrode gradually changes according to position.

5. The touch panel device of claim 2, wherein
at least one of a thickness of the fluent insulating layer and a thickness of the solid insulating layer changes according to position.

6. The touch panel device of claim 5, wherein
at least one of the thickness of the fluent insulating layer and the thickness of the solid insulating layer gradually changes according to position.

7. The touch panel device of claim 5, wherein
the fluent insulating layer includes a liquid crystal material.

8. The touch panel device of claim 2, further comprising:
a plurality of first input signal lines each connecting a first terminal of the upper electrode to the touch panel controller;
a plurality of first output signal lines each connecting a second terminal of the upper electrode to the touch panel controller;
a plurality of second input signal lines each connecting a first terminal of the lower electrode to the touch panel controller; and
a plurality of second output signal lines each connecting a second terminal of the lower electrode to the touch panel controller.

9. The touch panel device of claim 2, wherein
the plurality of first output signal lines are grouped as one signal line to be connected to the touch panel controller, and the plurality of second output signal lines are grouped as one signal line to be connected to the touch panel controller.

10. The touch panel device of claim 2, wherein
the fluent insulating layer includes a liquid crystal material.

11. The touch panel device of claim 2, wherein
the fluent insulating layer includes a plurality of spacers maintaining a thickness of the fluent insulating layer.

12. The touch panel device of claim 1, wherein
at least one of a thickness of the fluent insulating layer and a thickness of the solid insulating layer gradually change according to position.

13. The touch panel device of claim 11, wherein
the fluent insulating layer includes a liquid crystal material.

14. The touch panel device of claim 11, wherein
the fluent insulating layer includes a plurality of spacers maintaining a thickness of the fluent insulating layer.

15. The touch panel device of claim 1, wherein
the fluent insulating layer includes a liquid crystal material.

16. The touch panel device of claim 1, wherein
the fluent insulating layer includes a plurality of spacers maintaining a thickness of the fluent insulating layer.

17. A touch panel device comprising:
a touch panel; and
a touch panel controller for controlling the touch panel,
wherein the touch panel includes:
a lower electrode layer including a plurality of lower electrodes,
an insulating layer disposed on the lower electrode, and
an upper electrode layer disposed on the insulating layer and including a plurality of upper electrodes intersecting the lower electrodes,
wherein a width of the lower electrode or a width of the upper electrode is different according to position.

18. The touch panel device of claim 17, wherein
the width of the lower electrode or the width of the upper electrode gradually changes according to position.

19. The touch panel device of claim 17, further comprising:
a plurality of first input signal lines each connecting a first terminal of the upper electrode to the touch panel controller;
a plurality of first output signal lines each connecting a second terminal of the upper electrode to the touch panel controller;
a plurality of second input signal lines each connecting a first terminal of the lower electrode to the touch panel controller; and
a plurality of second output signal lines each connecting a second terminal of the lower electrode to the touch panel controller.

20. The touch panel device of claim 19, wherein
the plurality of first output signal lines are grouped as one signal line to be connected to the touch panel controller, and the plurality of second output signal lines are grouped as one signal line to be connected to the touch panel controller.
